(19) United States
(12) Patent Application Publication
(10) Pub. No.: US 2013/0153539 A1
(43) Pub. Date: Jun. 20, 2013

(54) FIBER REINFORCED INSULATION MATERIAL FOR EMBEDDED VACUUM INTERRUPTERS

(71) Applicant: ABB Technology AG, Zurich (CH)

(72) Inventors: Wenkai SHANG, Ratingen (DE); Christof Humpert, Willich (DE)

(73) Assignee: ABB Technology AG, Zurich (CH)

(21) Appl. No.: 13/766,262

(22) Filed: Feb. 13, 2013

Related U.S. Application Data
(63) Continuation of application No. PCT/EP2011/004059, filed on Aug. 12, 2011.

(30) Foreign Application Priority Data
Aug. 13, 2010 (EP) 10008457.3

(51) Int. Cl. H01H 33/53

(52) U.S. Cl. CPC H01H 33/53
USPC 218/134; 264/258

(57) ABSTRACT

A vacuum interrupter embedded in an insulating material is disclosed, the insulating material including a first main layer having a first sub-layer, a second sub-layer, and a third sub-layer. The second sub-layer is arranged between the first sub-layer and the third sub-layer. The first sub-layer, the second sub-layer, and the third sub-layer can include fibers, wherein the first sub-layer can include a group of first fibers which are arranged in parallel with respect to each other.

### RELATED APPLICATION(S)

This application claims priority as a continuation application under 35 U.S.C. §120 to PCT/EP2011/004059, which was filed as an International Application on Aug. 12, 2011, designating the U.S., and which claims priority to European Application No. 10008457.3 filed on Aug. 13, 2010. The entire contents of these applications are hereby incorporated by reference in their entireties.

### FIELD

The present disclosure relates to a vacuum interrupter embedded in an insulating material, to the use of an insulating material for embedding a vacuum interrupter, and to a method of embedding a vacuum interrupter in an insulating material.

### BACKGROUND INFORMATION

Embedded vacuum interrupters in suitable insulation material can provide an increased external dielectric strength of the vacuum interrupter compared to the insulation capacity of air and a protection against external mechanical influences such as impacts.

The insulating material can provide certain mechanical and electrical insulating properties in order to enable the increased external dielectric strength of the vacuum interrupters of the embedded vacuum interrupter and the mechanical protection against external mechanical influences.

### SUMMARY

A vacuum interrupter embedded in an insulating material is disclosed, the insulating material comprising: a first main layer having a first sub-layer, a second sub-layer, and a third sub-layer; wherein the second sub-layer is arranged between the first sub-layer and the third sub-layer; wherein the first sub-layer, the second sub-layer, and the third sub-layer comprise fibers; and wherein the first sub-layer comprises a group of first fibers which are arranged in parallel with respect to each other.

An insulating material, comprising: a first main layer having a first sub-layer, a second sub-layer, and a third sub-layer; wherein the second sub-layer is arranged between the first sub-layer and the third sub-layer; wherein the first sub-layer, the second sub-layer, and the third sub-layer include fibers; and wherein the first sub-layer includes a group of first fibers which are arranged in parallel with respect to each other.

A method of embedding a vacuum interrupter in an insulating material is disclosed, the method comprising: applying a first sub-layer to the vacuum interrupter; applying a second sub-layer to the first sub-layer; and applying a third sub-layer to the second sub-layer, wherein the first sub-layer, the second sub-layer, and the third sub-layer include fibers, and the first sub-layer includes a group of first fibers which are arranged in parallel with respect to each other.

### BRIEF DESCRIPTION OF THE DISCLOSURE

In the following, the disclosure will be explained in greater detail in the following text with reference to exemplary embodiments which are illustrated in the attached drawings.

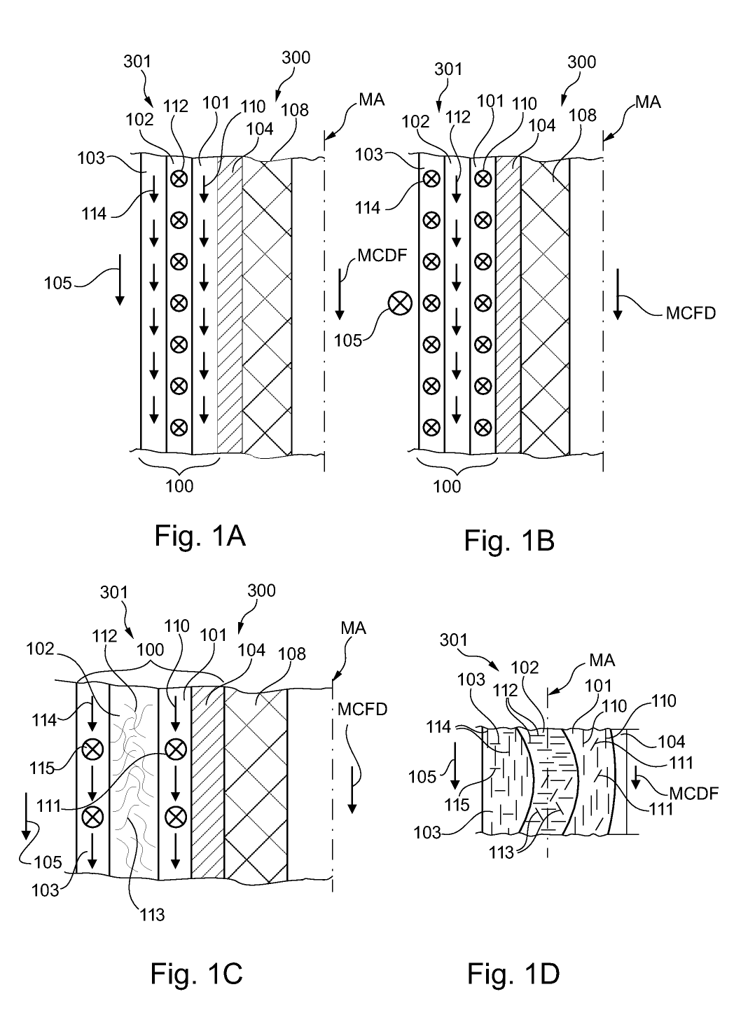

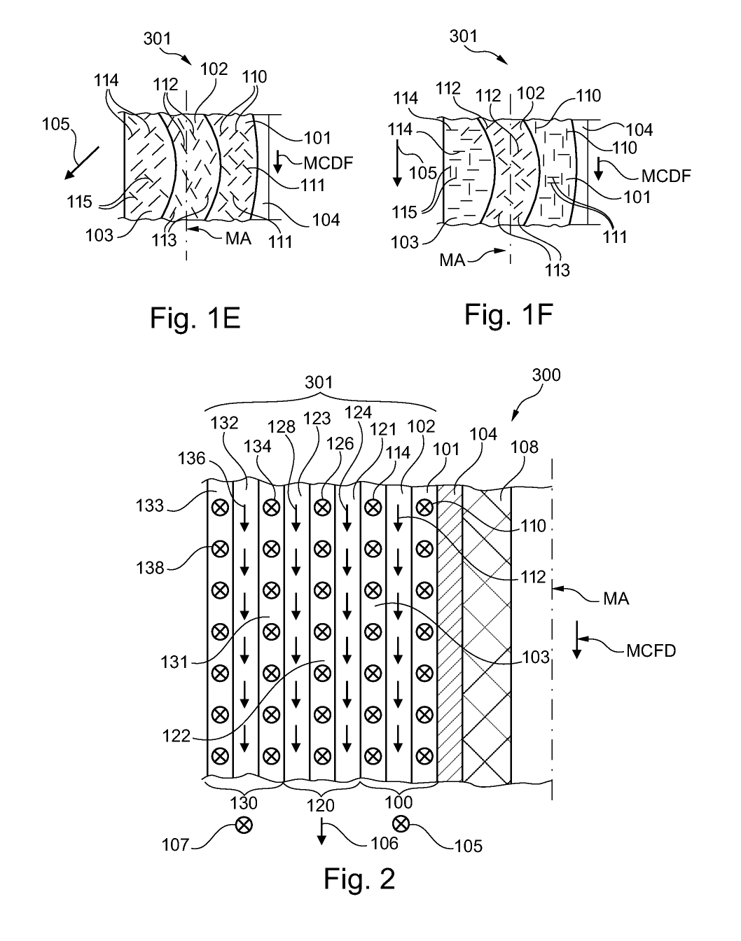

FIG. 1A shows a schematic cross-sectional view of parts of an exemplary vacuum interrupter embedded by an insulating material according to an exemplary embodiment of the disclosure.

FIG. 1B shows a schematic cross-sectional view of a part of an exemplary vacuum interrupter embedded in an insulating material according to an exemplary of the disclosure.

FIG. 1C shows a schematic cross-sectional view of a part of an exemplary vacuum interrupter embedded in an insulating material according to an exemplary embodiment of the disclosure.

FIG. 1D shows a schematic view of a part of the insulating material applied on the exemplary vacuum interrupter according to an exemplary embodiment of the disclosure.

FIG. 1E shows a schematic view of a part of the insulating material applied on the exemplary vacuum interrupter according to an exemplary embodiment of the disclosure.

FIG. 1F shows a schematic view of a part of the insulating material applied on the exemplary vacuum interrupter according to an exemplary embodiment of the disclosure.

FIG. 2 shows a cross-sectional view of a part of an exemplary vacuum interrupter embedded by an insulating material comprising three main layers according to an exemplary embodiment of the disclosure.

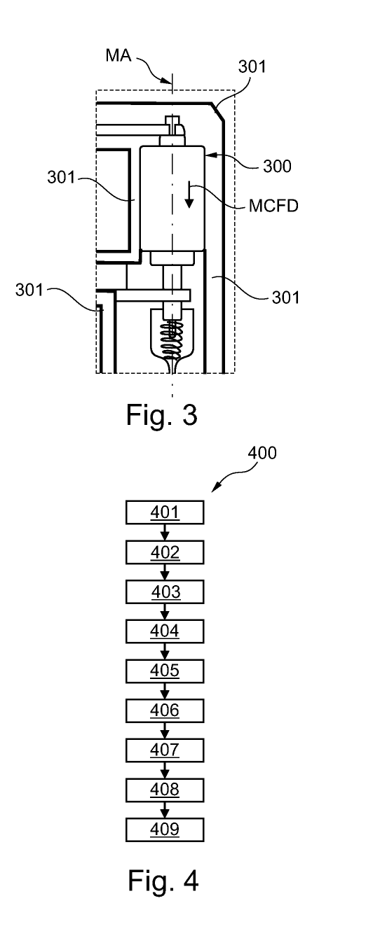

FIG. 3 shows a schematic cross-sectional view of an exemplary vacuum interrupter embedded in an insulating material according to an exemplary embodiment.

FIG. 4 shows a flow chart of a method for embedding an exemplary vacuum interrupter an insulating material according to an exemplary embodiment of the disclosure.

The reference symbols used in the drawings, and their meanings, are listed in summary form in a list of reference symbols. In principle, identical parts are provided with the same reference symbols in the figures.

### DETAILED DESCRIPTION

The disclosure relates to providing an insulating material to embed a vacuum interrupter to achieve, for example, an improved, efficient mechanical and electrical insulation of the embedded vacuum interrupter.

In accordance with an exemplary embodiment, a vacuum interrupter embedded in an insulating material, the use of an insulating material for embedding the vacuum interrupter, and a method of embedding the vacuum interrupter in an insulating material are disclosed.

According to an exemplary embodiment of the disclosure, a vacuum interrupter embedded in an insulating material is provided, the insulating material comprising a first main layer, having a first sub-layer, a second sub-layer, and a third sub-layer. The second sub-layer can be arranged between the first sub-layer and the third sub-layer, wherein the first sub-layer, the second sub-layer, and the third sub-layer comprises fibers. The first sub-layer comprises a group of first fibers which can be arranged in parallel with respect to each other, and parallel to the third sub-layer, the fiber orientation in second sub-layer can be vertical to the first and third sub-layer.

The fiber orientation can be of importance in order to get obtain mechanical strength for the embedded pole around the vacuum interrupter. The optimal fiber orientation can be achieved by suitable design of the applying mechanism of the insulating material to the vacuum interrupter to achieve the optimal performance of the embedded pole of the vacuum interrupter.

The insulating material with a first main layer having three sub-layers can increase external dielectric strength of the vacuum interrupter embedded by the insulating material compared to air as well as protection against external mechanical influences.

Furthermore, such a vacuum interrupter embedded in an insulating material as mentioned herein can also provide a usability of the embedded vacuum interrupter in a wide range of climatic conditions, as well as protection of the vacuum interrupter from dust, mechanical impact, and moisture.

With such an insulating material embedding the vacuum interrupter, an increased production reliability may be achieved with shortened production times, therefore making the manufacturing process of the insulating material to the vacuum interrupter more efficient.

The arrangement of three layers over each other, wherein the first sub-layer comprises a group of first fibers which are arranged in parallel with respect to each other allows for a good material efficiency optimizing the material use because of an improved strength and protection against mechanical impacts as well as atmospheric influences, such as rain, UV radiation, ice, snow, and extreme cold.

According to an exemplary embodiment of the disclosure the group of first fibers consists of for example, one of 10%, 20%, 25%, 30%, 40%, 45%, 50%, less than 50%, more than 50%, 60%, 70%, 75%, 80%, 90%, 100% of the fibers of the first sub-layer.

According to an exemplary embodiment of the disclosure, the second sub-layer comprises a group of second fibers which can be arranged in parallel with respect to each other.

According to an exemplary embodiment of the disclosure, the group of second fibers comprises, for example, one of 10%, 20%, 25%, 30%, 40%, 45%, 50%, more than 50%, less than 50%, 60%, 70%, 75%, 80%, 90%, 100% of the fibers of the second sub-layer.

According to an exemplary embodiment of the disclosure, the third sub-layer comprises a group of third fibers which can be arranged in parallel with respect to each other.

According to an exemplary embodiment of the disclosure, the group of third fibers comprises, for example, one of 10%, 20%, 25%, 30%, 40%, 45%, 50%, more than 50%, less than 50%, 60%, 70%, 75%, 80%, 90%, 100% of the fibers of the third sub-layer.

According to an exemplary embodiment of the disclosure, the first sub-layer comprises a group of fourth fibers which can be arranged in parallel with respect to each other but not parallel to the group of first fibers. Such an arrangement of fourth fibers not in parallel to the group of first fibers can allow for an improved strength of the first sub-layer, electrical and mechanical strength of the first sub-layer when applied to the vacuum interrupter, for example, on the compensation layer which is on the vacuum interrupter ceramic.

According to an exemplary embodiment of the disclosure, the orientation of the first fibers can be defined as a main fiber orientation of the first main layer, wherein the vacuum interrupter has a main axis corresponding to a main current flow direction of the vacuum interrupter. The orientation of the first fibers can be parallel or orthogonal to the main axis of the vacuum interrupter.

According to an exemplary embodiment, the orientation of the first fibers can be in any arbitrary angle to the main axis of the vacuum interrupter according to an exemplary embodiment of the disclosure.

According to an exemplary embodiment of the disclosure, the first fibers are orientated, for example, in one of a 0°-direction, a 30°-direction, a 45°-direction, a 60°-direction, and a 90°-direction with respect to the main axis of the vacuum interrupter.

According to an exemplary embodiment of the disclosure, the second sub-layer comprises a group of fifth fibers which can be arranged in parallel with respect to each other but not parallel to the group of second fibers.

According to an exemplary embodiment, such an arrangement of the fifth fibers not parallel to the second fibers may increase the electrical and mechanical strength of the second sub-layer itself, and when applied to the first sub-layer, the electrical and mechanical strength of the embedded vacuum interrupter.

According to an exemplary embodiment of the disclosure, the second fibers can be orientated in a direction which is not parallel to the direction of the first fibers.

According to an exemplary embodiment of the disclosure, the second fibers can be orientated, for example, in one of a 30°-direction, a 45°-direction, a 60°-direction and a 90°-direction with respect to the direction of the first fibers.

According to an exemplary embodiment of the disclosure, the third sub-layer comprises a group of sixth fibers which can be arranged in parallel with respect to each other but not parallel to the group of third fibers.

According to an exemplary embodiment of the disclosure, the third fibers can be orientated in a direction which is not parallel to the direction of the second fibers.

According to an exemplary embodiment of the disclosure, the third fibers are orientated, for example, in one of a 30°-direction, a 45°-direction, a 60°-direction, and a 90°-direction with respect to the direction of the second fibers.

According to an exemplary embodiment of the disclosure, the third fibers can be orientated parallel to the first fibers.

An arrangement of the first and third fibers in parallel to each other being part of the first sub-layer and the second sub-layer and a third sub-layer enclosing the second sub-layer can improve the electrical insulation and mechanical properties of the insulating material embedded vacuum interrupter.

According to an exemplary embodiment of the disclosure, the insulating material embedding the vacuum interrupter further comprises a second main layer, wherein the second main layer can be designed like the first main layer. The second main layer can be arranged with respect to the first main layer such that the main fiber orientation of the second main layer is not parallel to the main fiber orientation of the first main layer.

Such an arrangement can improve the electrical and mechanical strength of the insulating material comprising a first and a second main layer as well as by the insulating material embedded vacuum interrupter.

According to an exemplary embodiment of the disclosure, the second main layer can be arranged with respect to the first main layer such that the main fiber orientation of the second main layer is orientated, for example, in one of a 30°-direction, a 45°-direction, a 60°-direction, and a 90°-direction with respect to the main fiber orientation of the first main layer.

According to an exemplary embodiment of the disclosure, the insulating material of the vacuum interrupter further comprises at least one third, additional main layer, which can be designed like the first main layer.

According to an exemplary embodiment of the disclosure, the third main layer is arranged with respect to the second main layer such that the main fiber orientation of the third main layer is not parallel to the main fiber orientation of the second main layer.

Such an arrangement of the third main layer with respect to the second main layer can improve the electrical and mechanical strength of the insulating material comprising three main layers as well as the electrical and mechanical strength by the insulating material embedded vacuum interrupter.

According to an exemplary embodiment of the disclosure, the third main layer can be arranged with respect to the second main layer such that the main fiber orientation of the third main layer is orientated, for example, in one of 30°-direction, a 45°-direction, a 60°-direction, and a 90°-direction with respect to the main fiber orientation of the second main layer.

According to an exemplary embodiment of the disclosure, the third main layer can be arranged with respect to the second main layer such that the main fiber orientation of the third main layer is parallel to the main fiber orientation of the first main layer.

According to an exemplary embodiment of the disclosure, the insulating material comprises materials selected from the group comprising, for example, of a fiber reinforced thermoplastic, a fiber-reinforced thermoset, a mineral reinforced material, a mixture of a glass fiber and of a mineral reinforced material, a nano-particle reinforced material, and a mixture of a nano-particle reinforced glass fiber and of a mineral reinforced material and any combination of them.

According to an exemplary embodiment of the disclosure, the insulating material comprises, for example, a glass fiber reinforced thermoplastic based on one of semi-crystalline polyamide, partially aromatic copolyamides, a mixture of semi-crystalline polyamide and of aromatic copolyamides. The glass fiber reinforced thermoplastic may comprise a material selected from, for example, the group consisting of polyamide 6 (PA6), polyamide 66 (PA66), phenylpropanolamin 66 (PPA66), polyamide 6/6T (PA6/6T), polyamide 6I/6T (PA6I/6T), polyamide 6T/66 (PA6T/66), polyamide 12 (PA12), polyamide 612 (PA612), polyamide 12G (PA12G), polyamide-6-3 (PA-6-3), polyacrylic acid (PAA), phenylpropanolamin (P PA), polyamide MXD6 (PAMXD6), and a mixture of the above-mentioned material with additives.

According to an exemplary embodiment of the disclosure, the insulating material comprises, for example, a glass fiber reinforced thermoplastic based on one of a polyester-based polymer of the group consisting of polybutyleneterephthalate (PBT), polyethyleneterephthalate (PET), and a mixture of PBT and PET.

According to an exemplary embodiment of the disclosure, the insulating material comprises a mixture of above-mentioned polyester-based polymer and additives.

According to an exemplary embodiment of the disclosure, the insulating material comprises a glass fiber reinforced thermoplastic selected from the group consisting of, for example, polyphenylenether (PPE), polyetheretherketon (PEEK), Liquid Crystal Polymer (LCP), polyethersulfon (PES), polypropylen (PP), polyphenylensulfid (PPS), polyphenylsulfon (PPSU).

According to an exemplary embodiment of the disclosure, the insulating material comprises a glass fiber reinforced thermoset material selected from the group consisting, for example, of bulk molding compound (BMC), unsaturated polyester (UP), epoxy/epoxide (EP) material.

According to an exemplary embodiment of the disclosure, the use of an insulating material for embedding a vacuum interrupter according to anyone of the above-mentioned embodiments is disclosed, the insulating material comprising a first main layer having a first sub-layer, a second sub-layer, and a third sub-layer. The second sub-layer can be arranged between the first sub-layer and the third sub-layer. The first sub-layer, the second sub-layer, and the third sub-layer comprise fibers, wherein the first sub-layer comprises a group of first fibers which can be arranged in parallel with respect to each other.

According to an exemplary embodiment of the disclosure, a method of embedding a vacuum interrupter in an insulating material is disclosed, the method comprising the steps of applying a first sub-layer to the vacuum interrupter, applying a second sub-layer to the first sub-layer, and applying a third sub-layer to the second sub-layer. The first sub-layer, the second sub-layer, and the third sub-layer comprise fibers, wherein the first sub-layer comprises a group of first fibers, which can be arranged in parallel with respect to each other. In accordance with an exemplary embodiment, this can also be achieved by one production step.

Between the main layers and between the ceramic and main layers, if need, an adhesive layer (primer) could also be applied.

These and other aspects of the present disclosure will now be described with reference to the embodiments of the drawings.

FIG. 1A shows an exemplary vacuum interrupter 300 embedded in an insulating material 301. The vacuum interrupter 300 has a main axis MA corresponding to a main current flow direction MCFD of the vacuum interrupter 300. The insulating material 301, a ceramic layer 108, and a compensation layer 104 which is arranged at the ceramic layer 108. The insulating material 301 is arranged at the compensation layer 104 of the vacuum interrupter 300. The insulating material 301 comprises a first main layer 100 having a first sub-layer 101, a second sub-layer 102, and a third sub-layer 103, wherein the first sub-layer 101 is arranged to the compensation layer 104 of the vacuum interrupter.

The second sub-layer 102 is arranged between the first sub-layer 101 and the third sub-layer 103. The first sub-layer 101, the second sub-layer 102, and the third sub-layer 103 comprise fibers 110, 112, 114, wherein the first sub-layer 101 comprises a group of first fibers 110 which are arranged in parallel with respect to each other, the second sub-layer 102 comprises a group of second fibers 112 which are arranged in parallel with respect to each other, and the third sub-layer 103 comprises a group of third fibers 114 which are arranged in parallel with respect to each other.

The group of first fibers 110 comprises, for example, one of 10%, 20%, 25%, 30%, 40%, 45%, 50%, more than 50%, less than 50%, 60%, 70%, 75%, 80%, 90%, 100% of the fibers of the first sub-layer 101. The group of second fibers 112 can comprise the same portion of the fibers of the second sub-layer 102 as mentioned above. The group of third fibers 114 can comprise the same portions of the fibers of the third sub-layer 103 as mentioned above.

According to FIG. 1A the orientation of the first fibers 110 is parallel to the main axis MA of the vacuum interrupter. The orientation of the second fibers 112 is orthogonal with respect to the direction of the first fibers 110. The second fibers may be orientated, for example, in one of a 30°-direction, a 45°-direction, a 60°-direction, and a 90°-direction with respect to the direction of the first fibers.

The third fibers 114 are orientated in a direction which is not parallel to the direction of the second fibers 112. According to FIG. 1A the third fibers 114 are orientated orthogonal with respect to the direction of the second fibers 112 and parallel to the first fibers 110.

The third fibers 114 may be orientated, for example, in one of a 30°-direction, a 45°-direction, a 60°-direction, and a 90°-direction with respect to the direction of the second fibers 112.

The orientation of the first fibers 110 is defined as a main fiber orientation 105 of the first main layer 100.

FIG. 1B shows a schematic cross-sectional view of a part of an exemplary vacuum interrupter 300 embedded in insulating material 301 according to FIG. 1A with the difference, that the first fibers 110 of the first sub-layer 101 are orientated in a orthogonal direction to the main axis MA of the vacuum interrupter 300, as well as the third fibers 114 of the third sub-layer 103, which are also orientated in an orthogonal direction with respect to the main axis MA of the vacuum interrupter.

The second fibers 112 of the second sub-layer 102 which is arranged between the first sub-layer 101 and the third sub-layer 103, are orientated in an orthogonal direction with respect to the direction of the first fibers 110, and according to FIG. 1B parallel with respect to the main axis MA of the vacuum interrupter 300. The orientation of the first fibers 110 is defined as a main fiber orientation 105 of the first main layer 100, wherein the main fiber orientation 105 is orthogonal with respect to the main axis MA of the vacuum interrupter 300.

FIG. 1C shows a schematic cross-sectional view of the vacuum interrupter 300 embedded in an insulating material 301 of FIG. 1A with the difference, that the first sub-layer 101 comprises a group of first fibers 110 which are arranged in parallel with respect to each other, and a group of fourth fibers 111 which are arranged in parallel with respect to each other, and orthogonal with respect to the orientation of the first fibers 110. The third sub-layer 103 comprises a group of third fibers 114 which are arranged in parallel with respect to each other, and a group of sixth fibers 115 which are arranged in parallel with respect to each other, but orthogonal to the orientation of the third fibers 114.

The second sub-layer 102 which is arranged between the first sub-layer 101 and the third sub-layer 103, comprises a group of second fibers 112 which may be arranged in parallel with respect to each other, and a group of fifth fibers 113 which may be arranged in parallel with respect to each other, wherein the orientation of the fifth fibers 113 is not parallel to the orientation of the second fibers 112. In the exemplary embodiment of FIG. 1C, the fibers of the second sub-layer 102 are orientated arbitrarily.

The orientation of the first fibers 110 is again defined as a main fiber orientation 105 of the first main layer 100, which main fiber orientation 105 is parallel with respect to the main axis MA of the vacuum interrupter 300.

FIG. 1D shows a schematic view of a part of the insulating material 301 being applied to the exemplary vacuum interrupter 300, wherein a first sub-layer 101 of a first main layer 100 of the insulating material 301 is applied to a compensation layer 104 of the vacuum interrupter, the space of 104 can be partly filled or just keep open as air.

A group of first fibers 110 which are arranged in parallel with respect to each other of the first sub-layer 101 may have a 0° orientation, respectively a parallel orientation with respect to the main axis MA corresponding to a main current flow direction MCFD of the vacuum interrupter 300. The first sub-layer 101 further comprises a group of fourth fibers 111 which are arranged in parallel with respect to each other but not parallel to the group of first fibers 110.

A second sub-layer 102 is applied to the first sub-layer 101 and comprises a group of second fibers 112 which are arranged in parallel with respect to each other, and a group of first fibers 113 which are arranged in parallel with respect to each other but not parallel to the group of second fibers 112. The orientation of the second fibers 112 is orthogonal with respect to the orientation of the first fibers 110. The orientation of the second fibers 112 may be orientated, for example, in one of a 30°-direction, a 45°-direction, a 60°-direction, and a 90°-direction with respect to the direction of the first fibers 110. The second fibers 112 may also be orientated in a direction which is not parallel to the direction of the first fibers 110.

FIG. 1D shows a third sub-layer 103 applied to the second sub-layer 102 comprising a group of third fibers 114 which are arranged in parallel with respect to each other, and a group of sixth fibers 115 which are arranged in parallel with respect to each other but not parallel to the group of the third fibers 114.

The orientation of the first fibers 110 is defined as a main fiber orientation 105 of the first main layer 100 and is orientated parallel to the main axis MA of the vacuum interrupter 300 according to FIG. 1D.

FIG. 1E shows a schematic view of a part of the insulating material 301 being applied to the exemplary vacuum interrupter 300 according to FIG. 1D, with the difference that the orientation of the first fibers 110 is in an approximately 45°-direction with respect to the main axis MA of the vacuum interrupter 300. The fourth fibers 111 can be arranged orthogonal with respect to the orientation of the first fibers 110

The second fibers 112 and the first fibers 113 of the second layer can be orientated according to the orientation in FIG. 1C. The fibers 112, 113 of the second sub-layer 102 are arbitrarily orientated with respect to the main axis MA of the vacuum interrupter or with respect to the orientation of the first fibers 110.

The orientation of the third fibers 114 are not parallel with respect to the orientation of the second fibers 102, but essentially parallel with respect to the orientation of the first fibers 110.

The orientation of the sixth fibers 115 is basically orthogonal with respect to the orientation of the third fibers 114.

The main fiber orientation 105 of the first main layer 100, which is defined as the orientation of the first fibers 110 is basically orientated in a 45°-direction with respect to the main axis MA of the vacuum interrupter 300.

FIG. 1F shows a schematic view of the part of an insulating material 301 being applied to the vacuum interrupter according to FIG. 1D with the difference, that the group of fourth fibers 111 of the first sub-layer 101 can be orientated basically orthogonal with respect to the orientation of the first fibers 110 of the first sub-layer 101.

The orientation of the second fibers 112 of the second sub-layer 102 is essentially in a 45°-direction with respect to the orientation of the first fibers 110 of the first sub-layer 101. The fifth fibers 113 of the second sub-layer 102 are essentially arranged in an orthogonal direction with respect to the orientation of the second fibers 102.

The orientation of the third fibers 114 of the third sub-layer 103 is essentially parallel with respect to the orientation of the first fibers 110.

The orientation of the sixth fibers 115 of the third sub-layer 103 is essentially orthogonal with respect to the orientation of the third fibers 114.

The main fiber orientation 105 of the first main layer 100 which basically corresponds to the orientation of the first fibers 110 is parallel to the main axis MA of the vacuum interrupter 300.

FIG. 2 shows a schematic cross-sectional view of a part of a vacuum interrupter 300 embedded in an insulating material 301. The vacuum interrupter 300 has a main axis MA corresponding to a main current flow direction MCFD, and a ceramic layer 108 onto which a compensation layer 104 is applied, onto which the insulating material 301 is applied starting with a first main layer 100, followed by a second main layer 120, and a third main layer 130 of the insulating material 301.

A first sub-layer 101 of the first main layer 100 is applied to the compensation layer 104 of the vacuum interrupter 300. The first sub-layer 101 comprises a group of first fibers 110 which are arranged in parallel with respect to each other, and orthogonal to the main axis MA of the vacuum interrupter 300. A second sub-layer 102 of the first main layer 100 is applied to the first sub-layer 101 and comprises a group of second fibers 112 which are arranged in parallel with respect to each other, and orthogonal with respect to the orientation of the first fibers 110

A third sub-layer of the first main layer 100 is applied to the second sub-layer 102, and comprises a group of third fibers 114 which are arranged in parallel with respect to each other, orthogonal with respect to the orientation of the second fibers 112, and parallel with respect to the first fibers 110. The orientation of the first fibers 110 is defined as a main fiber orientation 105 of the first main layer, which main fiber orientation 105 is orthogonal to the main axis MA of the vacuum interrupter 300.

A first sub-layer 121 of the second main layer 120 is applied to the third sub-layer 103 of the first main layer 100 and comprises a group of seventh fibers 121 which are arranged in parallel with respect to each other, and in an orthogonal direction with respect to the orientation of the third fibers 114 of the first main layer 100, when it is needed between sub-layer 120 and 100, an extra layer of adhesive material could be applied, to promote better adhesion between main layer.

A second sub-layer 122 of the second main layer 120 is applied to the first sub-layer 121 of the second main layer 120, and comprises a group of ninth fibers 126 which are arranged in parallel with respect to each other, and essentially orthogonal with respect to the orientation of the seventh fibers 124.

A third sub-layer 123 of the second main layer 120 is applied to the second sub-layer 122 of the second main layer 120, and comprises a group of eleventh fibers 128 which are arranged in parallel with respect to each other, and orthogonal with respect to the orientation of the ninth fibers 126.

The orientation of the seventh fibers 124 is defined as a main fiber orientation 106 of the second main layer 120, which orientation is not parallel to the main fiber orientation 105 of the first main layer 100. The second main layer 120 may be arranged with respect to the first main layer 100 such that the main fiber orientation 106 of the second main layer 120 is orientated, for example, in one of a 30°-direction, a 45°-direction, a 60°-direction, and a 90°-direction with respect to the main fiber orientation 105 of the first main layer 100.

A first sub-layer 131 of a third main layer 130 is applied to the third sub-layer 123 of the second main layer 120, and comprises a group of thirteenth fibers 134 which are arranged in parallel with respect to each other, and orthogonal with respect to the orientation of the eleventh fibers 128 of the third sub-layer 123 of the second main layer 120.

A second sub-layer 132 of the third main layer 130 is applied to the first sub-layer 131, and comprises a group of fifteenth fibers 136 which are arranged in parallel with respect to each other, and orientated orthogonal with respect to the orientation of the thirteenth fibers 134.

A third sub-layer 133 of the third main layer 130 is applied to the second sub-layer 132 of the third main layer 130, and comprises a group of seventeenth fibers 133 which are arranged in parallel with respect to each other, and orthogonal with respect to the orientation of the fifteenth fibers 132. A main fiber orientation 107 of the third main layer 130 is defined by the orientation of the thirteenth fibers 134 of the first sub-layer 131 of the third main layer 130, and arranged such that the main fiber orientation 107 of the third main layer 130 is not parallel to the main fiber orientation 106 of the second main layer 120.

The third main layer 130 may be arranged to the second main layer 120 such that the main fiber orientation 107 of the third main layer 130 is orientated, for example, in one of a 30°-direction, a 45°-direction, a 60°-direction, and a 90°-direction with respect to the main fiber orientation 106 of the second main layer 120.

The second main layer 120 and the third main layer 130 may be designed like the first main layer 100.

The third main layer 130 may be arranged with respect to the second main layer 120 such that the main fiber orientation 107 of the third main layer 130 is parallel to the main fiber orientation 105 of the first main layer 100.

FIG. 3 shows an exemplary vacuum interrupter 103 embedded in an insulating material 301. The insulating material 301 may comprise a first main layer 100, a second main layer 120 and a third main layer 130 according to FIG. 1A to FIG. 1F, and FIG. 2, respectively, between the main layer, fully, partly or empty with 104.

The insulating material mentioned above, may comprise a material selected from the group comprising, for example, a fiber reinforced thermoplastic, a fiber-reinforced thermoset, a mineral reinforced material, a mixture of a glass fiber and of a mineral reinforced material, a nano-particle reinforced material, and a mixture of a nano-particle reinforced glass fiber and of a mineral reinforced material.

The insulating material may comprise, for example, a glass fiber reinforced thermoplastic based on one of semi-crystalline polyamide, partially aromatic co-polyamides, a mixture of semi-crystalline polyamides and of aromatic co-polyamides.

The glass fiber reinforced thermoplastic may comprise, for example, one of a material selected from the group consisting of PA6, PA66, PPA66, PA6/6T, PA6I/6T, PA6T/66, PA12, PA612, PA12G, PA-6-3, PAA, PPA, and PAMXD6, and a mixture of the above-mentioned material with additives.

Furthermore the insulating material may comprise, for example, a glass fiber reinforced thermoplastic based on one of a polyester-based polymer of the group consisting of PBT, PET, and a mixture of PBT and PET, and a mixture of the above-mentioned polyester-based polymers and additives.

The insulating material may comprise, for example, a glass fiber reinforced thermoplastic selected from the group consisting of PPE, PEEK, LCP, PES, PP, PPS, PPSU.

Furthermore, the insulating material may comprise, for example, a glass fiber reinforced thermoset material selected from the group consisting of BMC, UP, EP material.

FIG. 4 shows an exemplary schematic flow-chart of a method 400 of embedding an exemplary vacuum interrupter in an insulating material, with the steps of: applying a first sub-layer 401 to the vacuum interrupter 400; applying a second sub-layer 402 to the first sub-layer 401; applying a third sub-layer 403 to the second sub-layer 402, wherein the first sub-layer 401, the second sub-layer 402, and the third sub-layer 402 comprise fibers, wherein the first sub-layer comprises a group of first fibers which are arranged in parallel with respect to each other. The sub-layer 401, 402, 403 could be made at one step, for example, by injection molding.

The method 400 of FIG. 4 describes steps of applying a first sub-layer of 404 a second main layer to the third sub-layer of the first main layer 403; applying a second sub-layer 405 of the second main layer to the first sub-layer 404 of the second main layer; applying a third sub-layer 406 of the second main layer to the second sub-layer of the second main layer; applying a first sub-layer of a third main layer 407 to the third sub-layer of the second main layer; applying a second sub-layer 408 of the third main layer to the first sub-layer of the third main layer; and applying a third sub-layer 409 of the third main layer to the second sub-layer of the third main layer.

The layer 404, 405, 406 could be made with one step like by injection molding, and the same apply to layers 407, 408 and 409.

While the disclosure has been illustrated and described in detail in the drawings and the foregoing description, such illustration and description are to be considered illustrative or exemplary and not restricted; the disclosure is not limited to the disclosed embodiments.

Other variations of the disclosed embodiments may be understood and effected by those skilled in the art and practicing the claimed disclosure, from a study of the drawings, the disclosure, and the appended claims.

In the claims the word “comprising” does not exclude other elements or steps, and the indefinite article “a” or “an” does not exclude a plurality. An insulating material with a single sub-layer may fulfill further functions of several items recited in the claims. The fact that certain measures are recited in mutually different dependent claims does not indicate, that a combination of these measures may not be used to advantage. Any reference signs in the claims should not be construed as limiting the scope.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

100 First main layer
101 First sub-layer
102 Second sub-layer
103 Third sub-layer
104 Compensation layer, partly or fully filled, or only air
105 Main fiber orientation of the first main layer
106 Main fiber orientation of the second main layer
107 Main fiber orientation of the third main layer
108 Vacuum interrupter ceramic layer
110 Group of first fibers, first fibers
111 Group of fourth fibers, fourth fibers
112 Group of second fibers, second fibers
113 Group of fifth fibers, fifth fibers
114 Group of third fibers, third fibers
115 Group of sixth fibers, sixth fibers
120 Second main layer
121 First sub-layer of second main layer, first sub-layer
122 Second sub-layer of second main layer, second sub-layer
123 Third sub-layer of second main layer, third sub-layer
124 Group of seventh fibers, seventh fibers
126 Group of ninth fibers, ninth fibers
128 Group of eleventh fibers, eleventh fibers
130 Third main layer
131 First sub-layer of third main layer, first sub-layer
132 Second sub-layer of third main layer, second sub-layer
133 Third sub-layer of third main layer, third sub-layer
134 Group of thirteenth fibers, thirteenth fibers
136 Group of fifteenth fibers, fifteenth fibers
138 Group of seventeenth fibers, seventeenth fibers
300 Vacuum interrupter
301 Insulating material
MA Main axis of the vacuum interrupter
MCFD Main current flow direction of the vacuum interrupter

What is claimed is:

1. Vacuum interrupter embedded in an insulating material, the insulating material comprising:
a first main layer having a first sub-layer, a second sub-layer, and a third sub-layer;
wherein the second sub-layer is arranged between the first sub-layer and the third sub-layer;
wherein the first sub-layer, the second sub-layer, and the third sub-layer comprise fibers; and
wherein the first sub-layer comprises a group of first fibers which are arranged in parallel with respect to each other.

2. The vacuum interrupter of claim 1,
wherein an orientation of the first fibers is defined as a main fiber orientation of the first main layer;
wherein the vacuum interrupter has a main axis (MA) corresponding to a main current flow direction (MCFD) of the vacuum interrupter; and
wherein the orientation of the first fibers is parallel or orthogonal to the main axis (MA) of the vacuum interrupter.

3. The vacuum interrupter of claim 1, wherein the second sub-layer comprises:
a group of second fibers which are arranged in parallel with respect to each other.

4. The vacuum interrupter of claim 3, wherein the second fibers are orientated in a direction which is not parallel to a direction of the first fibers.

5. The vacuum interrupter of claim 3, wherein the second fibers are orientated in one of a 30°-direction, a 45°-direction, a 60°-direction, and a 90°-direction with respect to a direction of the first fibers.

6. The vacuum interrupter of claim 3, wherein the third sub-layer comprises:
a group of third fibers which are arranged in parallel with respect to each other.

7. The vacuum interrupter of claim 6, wherein the third fibers are orientated in a direction which is not parallel to the direction of the second fibers.

8. The vacuum interrupter of claim 6, wherein the third fibers are orientated in one of a 30°-direction, a 45°-direction, a 60°-direction, and a 90°-direction with respect to the direction of the second fibers.

9. The vacuum interrupter of claim 6, wherein the third fibers are orientated parallel to the first fibers.

10. The vacuum interrupter of claim 1, wherein the insulating material comprises:
a second main layer, the second main layer having a first sub-layer, a second sub-layer, and a third sub-layer, wherein the second sub-layer is arranged between the first sub-layer and the third sub-layer of the second main layer;
wherein the first sub-layer, the second sub-layer, and the third sub-layer of the second main layer include, with the first sub-layer of the second main layer having a group of first fibers which are arranged in parallel with respect to each other; and
wherein the second main layer is arranged with respect to the first main layer such that a main fiber orientation of the second main layer is not parallel to a main fiber orientation of the first main layer.

11. The vacuum interrupter of claim 10, wherein the second main layer is arranged with respect to the first main layer such that the main fiber orientation of the second main layer is orientated in one of a 30°-direction, a 45°-direction, a 60° direction, and a 90° direction with respect to the main fiber orientation of the first main layer.

12. The vacuum interrupter of claim 10, wherein the insulating material comprises:
at least one third main layer, the at least one third main having a first sub-layer, a second sub-layer, and a third sub-layer, wherein the second sub-layer is arranged between the first sub-layer and the third sub-layer of the third main layer;
wherein the first sub-layer, the second sub-layer, and the third sub-layer of the at least one third main layer include fibers, with the first sub-layer of the second main layer having a group of first fibers which are arranged in parallel with respect to each other; and
wherein the third main layer is arranged with respect to the second main layer such that a main fiber orientation of the third main layer is not parallel to the main fiber orientation of the second main layer.

13. The vacuum interrupter of claim 1, wherein the insulating material comprises:
a material selected from a group consisting of a fiber reinforced thermoplastic, a fiber reinforced thermoset, a mineral reinforced material, a mixture of a glass fiber and of a mineral reinforced material, a nano-particle reinforced material, and a mixture of a nano-particle reinforced glass fiber and of a mineral reinforced material.

14. An insulating material, comprising:
a first main layer having a first sub-layer, a second sub-layer, and a third sub-layer;
wherein the second sub-layer is arranged between the first sub-layer and the third sub-layer;
wherein the first sub-layer, the second sub-layer, and the third sub-layer include fibers; and
wherein the first sub-layer includes a group of first fibers which are arranged in parallel with respect to each other.

15. The insulating material of claim 14, in combination with a vacuum interrupter,
wherein an orientation of the first fibers is defined as a main fiber orientation of the first main layer.

16. The insulating material of claim 14, comprising:
a second main layer, the second main layer having a first sub-layer, a second sub-layer, and a third sub-layer, wherein the second sub-layer is arranged between the first sub-layer and the third sub-layer of the second main layer;
wherein the first sub-layer, the second sub-layer, and the third sub-layer of the second main layer include fibers, with the first sub-layer of the second main layer having a group of first fibers which are arranged in parallel with respect to each other; and
wherein the second main layer is arranged with respect to the first main layer such that a main fiber orientation of the second main layer is not parallel to a main fiber orientation of the first main layer.

17. The insulating material of claim 14, comprising:
at least one third main layer, the at least one third main having a first sub-layer, a second sub-layer, and a third sub-layer, wherein the second sub-layer is arranged between the first sub-layer and the third sub-layer of the third main layer:
wherein the first sub-layer, the second sub-layer, and the third sub-layer of the at least one third main layer include fibers, with the first sub-layer of the second main layer having a group of first fibers which are arranged in parallel with respect to each other; and
wherein the third main layer is arranged with respect to the second main layer such that a main fiber orientation of the third main layer is not parallel to a main fiber orientation of the second main layer.

18. Method of embedding a vacuum interrupter in an insulating material, the method comprising:
applying a first sub-layer to the vacuum interrupter;
applying a second sub-layer to the first sub-layer; and
applying a third sub-layer to the second sub-layer, wherein the first sub-layer, the second sub-layer, and the third sub-layer include fibers, and the first sub-layer includes a group of first fibers which are arranged in parallel with respect to each other.

19. Method according to claim 18, comprising:
injection molding the first, the second and the third sub-layers.

20. Method according to claim 18, comprising:
arranging between the vacuum interrupter and the layers, a no filled air gap, or a partly filled gap, or fully filled gap with compensation and/or adhesive material.
